(19) United States
(12) Patent Application Publication
(10) Pub. No.: US 2023/0382060 A1
(43) Pub. Date: Nov. 30, 2023

(54) SYSTEM AND METHOD FOR INDUCTION FUSING OF THERMOPLASTIC COMPOSITES

(71) Applicant: Spirit AeroSystems, Inc., Wichita, KS (US)

(72) Inventors: W. Robert Nelson, Wichita, KS (US); Audra Morgan, Wichita, KS (US)

(21) Appl. No.: 18/319,194

(22) Filed: May 17, 2023

Related U.S. Application Data
(60) Provisional application No. 63/345,086, filed on May 24, 2022.

(51) Int. Cl. B29C 65/00; B29C 70/44

(52) U.S. Cl. CPC B29C 66/73921; B29C 70/44; B29C 66/81453; B29K 2101/12

(57) ABSTRACT

Embodiments of the present invention relate to an apparatus and method for induction fusing of thermoplastic composite materials using a film of pressurized air to provide active cooling as well as consolidation pressure. The invention may be employed to weld multiple pre-consolidated thermoplastic composite laminates or to form a single laminate from individual plies of thermoplastic composite material.

### BACKGROUND

### Field

Embodiments of the present invention relate to an apparatus and method for induction fusing of thermoplastic composite materials.

### Related Art

Thermoplastic composite materials have long been of interest to aerostructures manufacturers because they offer certain potential advantages when compared to more conventional thermoset composite materials. Unlike thermosets, thermoplastic materials can be re-melted after solidification, thus facilitating recycling of both manufacturing waste and completed aerostructures at the end of their life cycles. This capability can reduce environmental externalities relating to both disposal of waste and manufacture of new material. The same re-meltable characteristic of thermoplastics that facilitates recycling also enables thermoplastic components to be joined into assemblies by fusing (welding) rather than relying exclusively on fasteners, thereby potentially reducing an assembly's weight as well as simplifying its manufacture.

Unfortunately, existing thermoplastic welding processes and equipment have drawbacks that have limited the adoption of thermoplastics in the aerospace industry. Some known welding techniques employ metallic mesh susceptors that remain embedded in the weld line after the constituent components are joined. This adds weight and reduces weld strength and reliability. Other known welding techniques melt the components to be welded through their full thicknesses, necessitating complex tooling or pressure application means to prevent deconsolidation, and reducing process robustness. Susceptorless induction welding is perhaps the most promising technology under development due to its ability to directly heat conductive fibers such as carbon fibers present in composite laminates, without leaving a susceptor in the weld line.

Although a rapidly alternating magnetic field emanating from an induction coil can directly heat conductive fibers in all layers of a thermoplastic composite laminate, even those layers spaced further apart from the induction coil, different layers will receive different amounts of energy. The strength of a magnetic field decreases with distance in accordance with the inverse square law. Therefore, surface layers positioned nearer the induction coil are heated much more strongly than layers further away. To avoid overheating of layers near the surface, causing the thermoplastic material to degrade, and to prevent softening of layers within the laminate, causing delamination, it has been proposed to actively cool the exposed surface of a thermoplastic workpiece nearest the induction coil while simultaneously applying induction energy to the workpiece.

This approach is described in Italian Patent ITTO20130367A1 (“Pappada”) and it represented a significant advance in the art of induction welding when disclosed. It has been demonstrated that the Pappada approach can achieve a more uniform through-thickness heat distribution than prior induction heating approaches. However, important limitations have remained, preventing widespread adoption of susceptorless thermoplastic induction welding. In particular, the single large roller employed by Pappada to apply clamping force to the workpieces to be welded is spaced apart from the induction heating coil. Thus, the Pappada device cannot apply clamping force at the same location at which induction heat is applied, and cannot maintain clamping pressure over any significant area at once. The result is an inability to maintain pressure at any given location over time without sacrificing process speed. Furthermore, Pappada's air impingement cooling method operates in free air, so its ability to transfer heat out of the workpieces is limited by boundary layer phenomena.

A significant advance over the Pappada invention has recently been disclosed in U.S. patent application Ser. No. 17/207,647 (“Seneviratne”). The Seneviratne invention provides a plurality of small rollers to apply pressure to the workpieces in place of the single roller of Pappada, thus enabling clamping pressure to be maintained over a greater area and for a greater period of time for a given process speed. The Seneviratne invention also enables clamping pressure to be applied to a workpiece at the same location as the induction energy is introduced, and at the same time, which was not possible with the Pappada device. However, although clamping pressure is applied more evenly over a larger area by the Seneviratne invention, the pressure is still not entirely uniform due to the discrete contact locations inherent in a roller based design. The Seneviratne invention is also limited by its reliance on conduction to transfer heat out of the workpiece and into the rollers. The interface area between a roller and any flat workpiece is infinitesimally small, limiting the potential for heat transfer even where multiple rollers are employed. This heat transfer limitation is exacerbated by the need for the rollers to be made of a material with a low electrical conductivity (to avoid interaction with the induction field), as most materials with low electrical conductivity have a correspondingly low thermal conductivity. In addition, the rollers, being closely spaced as they must be to apply a relatively uniform pressure, form a barrier, blocking airflow that might otherwise be employed to supplement the cooling of the workpiece in the region of the induction coil. Finally, the large standoff distance resulting from positioning the induction coil on the opposite side of the rollers from the workpiece limits the precision with which the boundary of the heated zone of the workpiece can be controlled, and necessitates the generation of a more powerful induction field than would otherwise be required. Such a powerful induction field may heat any highly conductive (e.g., metallic) components of the equipment, and especially any ferromagnetic components, even when they may be positioned a significant distance away, complicating the design of equipment used to implement the Seneviratne invention. Furthermore, the higher energy expenditure required to generate a more powerful induction field is inconsistent with the sustainability goals of the aerospace industry.

### SUMMARY

The present invention overcomes the above-described limitations of the prior art and provides a distinct advance in the art of thermoplastic composite manufacture. It is an object of the present invention to provide a thermoplastic induction fusing apparatus capable of applying a more uniform pressure to the fusing area than prior art thermoplastic induction fusing devices. It is a further object of the present invention to provide a thermoplastic induction fusing apparatus capable of accommodating workpiece contour variations without adjustment. It is a further object of the present invention to provide a thermoplastic induction fusing apparatus with enhanced ability to transfer heat away from the workpiece. It is a further object of the present invention to provide a method by which thermoplastic workpieces may be fused together by means of induction.

An apparatus is disclosed herein for fusing a far surface of a near thermoplastic workpiece to a near surface of a far thermoplastic workpiece. The apparatus comprises an induction coil configured to heat a fusing area of the near workpiece and the far workpiece. The apparatus further comprises an air cushion block configured to emit compressed air against a near surface of the near thermoplastic workpiece in the fusing area, urging the near thermoplastic workpiece toward the far thermoplastic workpiece.

A system is disclosed herein for fusing a thermoplastic composite material. The system comprises an induction fusing apparatus. The system further comprises a pressurized fluid disposed between the induction fusing apparatus and the thermoplastic composite material. The system further comprises an assembly tool configured to react force applied by the pressurized fluid to the thermoplastic composite material. The system further comprises a manipulator configured to move the induction fusing apparatus along a surface of the thermoplastic composite material.

A method is disclosed herein for applying heat and pressure to a work area of a workpiece. The method comprises exposing the workpiece to an alternating magnetic field in the work area. The method further comprises positioning a surface of a reaction block proximate to, but spaced apart from, a surface of the workpiece in the work area. The method further comprises introducing a pressurized fluid into the gap between the surface of the reaction block and the surface of the workpiece.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is an illustration of a prior art system for induction welding taken from Italian Patent ITTO20130367A1 (Pappada).

FIG. 2 is an illustration of a second prior art system for induction welding taken from U.S. patent application Ser. No. 17/207,647 (Seneviratne).

FIG. 3 is a perspective view of a manufacturing cell for joining two thermoplastic composite workpieces by means of an induction fusing apparatus according to an embodiment of the present invention.

FIG. 4 is a perspective view of an induction fusing apparatus according to an embodiment of the present invention.

FIG. 5 is a schematic depiction of the relationship between the induction power supply and the induction coil of an induction fusing apparatus according to an embodiment of the present invention.

FIG. 6 is a simplified illustration of the air cushion block component of the induction fusing apparatus of FIG. 4.

FIG. 7 is a simplified illustration of the air cushion block component of an induction fusing apparatus according to another embodiment of the present invention.

FIG. 8A is a simplified illustration of the air cushion block component of an induction fusing apparatus according to yet another embodiment of the present invention.

FIG. 8B is a simplified illustration of the air cushion block component of FIG. 8A in a conformed condition.

FIG. 9A is a simplified illustration of the air cushion block component of an induction fusing apparatus according to yet another embodiment of the present invention.

FIG. 9B is a simplified illustration of the air cushion block component of FIG. 9A in a conformed condition.

FIG. 10 is a simplified illustration of the air cushion block component of an induction fusing apparatus according to yet another embodiment of the present invention.

FIG. 11 is a perspective view of portions of an induction fusing apparatus according to yet another embodiment of the present invention.

FIG. 12 is a simplified illustration of a system for laminating plies of thermoplastic material according to an embodiment of the present invention.

FIG. 13 is a flow chart depicting steps in a method of fusing two thermoplastic composite workpieces in accordance with an embodiment of the present invention.

### DETAILED DESCRIPTION

The following detailed description makes reference to accompanying drawings that illustrate specific embodiments of the present invention. Separate references to “an embodiment” or “one embodiment” do not necessarily refer to the same embodiment, though they may. The specific embodiments illustrated and/or described in detail in this disclosure are included to enable those skilled in the art to practice the invention. Other embodiments and variations will be apparent to those skilled in the art and may be substituted without departing from the scope of the present invention. Therefore, the detailed description that follows should not be construed in a limiting sense.

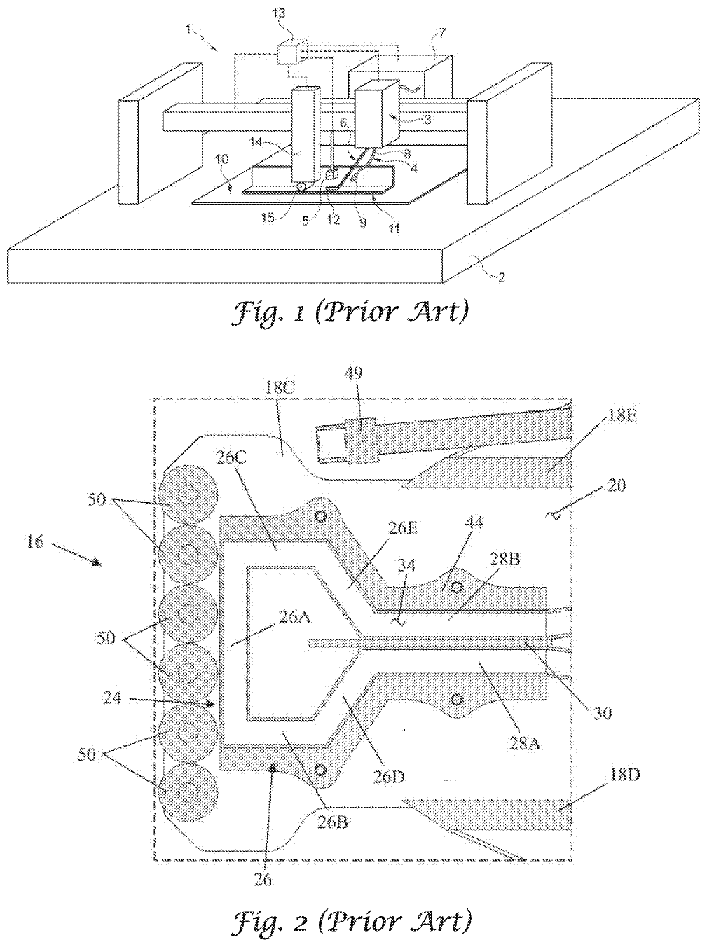

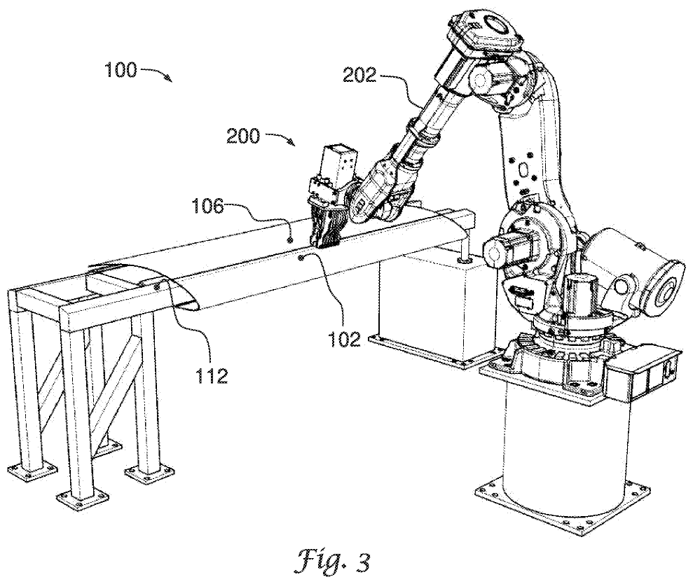

Referring now to the drawings, wherein like reference numerals designate identical or corresponding parts throughout the several views, a system 100 in accordance with an embodiment of the present invention is illustrated in FIG. 3. The system 100 overcomes certain limitations of the prior art systems depicted in FIGS. 1 and 2, as discussed in the BACKGROUND section above. The system 100 may comprise an induction fusing apparatus 200, which may be positioned by a manipulator 202. The fusion of the workpieces 102 and 106 may be completed by the action of the induction fusing apparatus 200 which has means to apply heat and pressure to a fusing area. The fusing area may be an area of the workpieces 102, 106 in close proximity to the induction fusing apparatus 200, wherein the interface between workpieces 102 and 106 in such fusing area fuses. The induction fusing apparatus 200 may be moved from a first fusing area to a second fusing area in order to fuse a larger area of the workpieces 102, 106 than would be possible from a single location. The induction fusing apparatus 200 may fuse a far surface 104 of a near workpiece 102 to a near surface 108 of a far workpiece 106. A far surface 110 of the far workpiece 106 may rest on a tool surface 112 and the tool surface 112 may react forces introduced into the far workpiece 106 by the manipulator 202 through the induction fusing apparatus 200 and the near workpiece 102. The tool surface 112 may be a surface of the tool that that was used for laminating at least one of the workpieces 102, 106, or it may be a separate assembly tool as depicted in FIG. 3 that acts as a jig to hold the workpieces during assembly. The terms “far” and “near” are used herein to describe the position of workpieces and surfaces from the perspective of the induction fusing apparatus 200. For example, near workpiece 102 is nearer the induction fusing apparatus 200 than far workpiece 106.

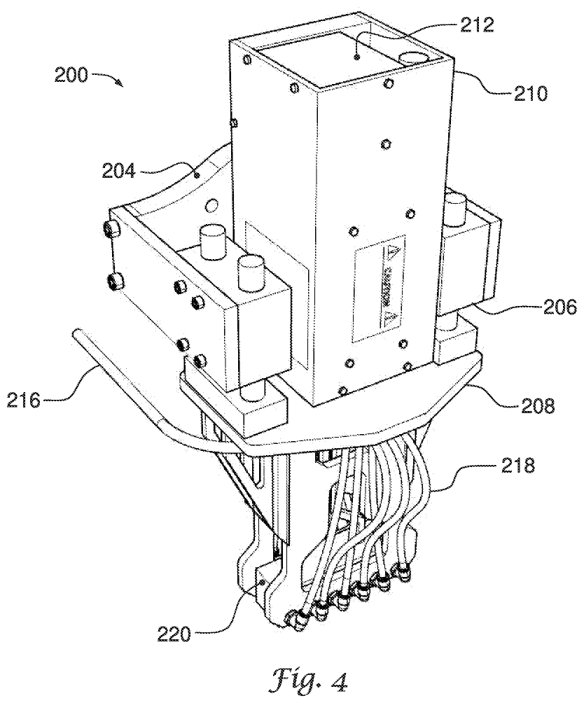

Referring now to FIG. 4, the induction fusing apparatus 200 may comprise a main frame 204 configured to interface with the manipulator 202. The main frame 204 may be coupled to pneumatic slides 206, which may in turn be coupled to the secondary frame 208. The pneumatic slides 206 may serve to establish a slidably coupled relationship between the main frame 204 and the secondary frame 208, and may further provide a biasing force to urge the secondary frame 208 to translate along its sliding axis away from the main frame 204.

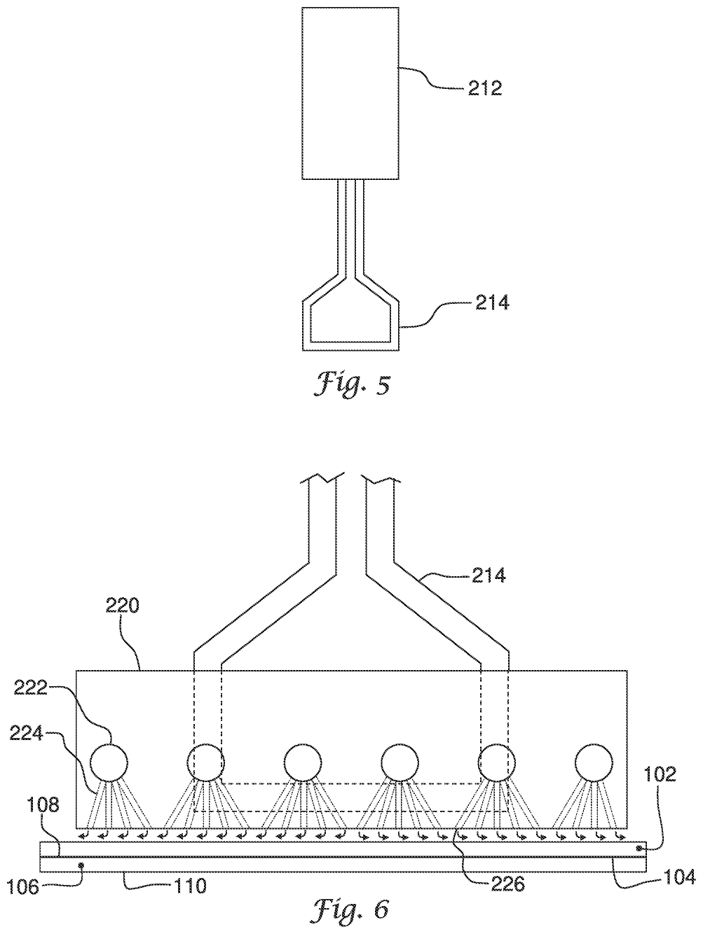

The secondary frame 208 may be mechanically coupled to the air cushion block 220, which may also be described as a “reaction block.” The air cushion block 220 is described in more detail below and in the various figures. Primary air line 216 is in fluid communication via a manifold (not shown) with secondary air lines 218, which are in turn in fluid communication with the air cushion block 220. The induction power supply 212 may be electrically coupled to the induction coil 214 as illustrated in FIG. 5. The induction coil 214 may be mechanically coupled to the air cushion block 220. However, in some embodiments, the induction coil 214 may be received in a recess of the air cushion block 220 or otherwise positioned proximate to the air cushion block 220 and the workpiece 102 without mechanical attachment of the induction coil 214 to the air cushion block 220. In some embodiments, the induction coil 214 may be attached to the air cushion block 220 in a manner allowing a degree of relative motion between the air cushion block 220 and the induction coil 214. Although only one broad configuration of induction coil is illustrated in the figures, it is contemplated that other induction coil types known in the art may be applied to the present invention, such as “pancake” type induction coils. The induction power supply 212 may be contained within a housing 210, which may be mechanically coupled to either the main frame 204 or the secondary frame 208. In the event the housing 210 is mechanically coupled to the main frame, the induction coil 214 may be configured to accommodate changes in distance between the air cushion block 220 and the induction power supply 212.

Referring now to FIG. 6, the air cushion block 220 may receive compressed air from secondary air lines 218 at inlets 222. The inlets 222 may be in fluid communication with a plurality of passages 224, each of which may convey compressed air from an inlet 222 to an outlet orifice 226. The outlet orifices 226 may be distributed over a surface of the air cushion block 220 facing the workpiece 102. Air emerging from the outlet orifices 226 is represented by arrows in FIG. 6. This air is constrained between a surface of the air cushion block 220 and the workpiece 102, and can only escape by migrating to the periphery of the air cushion block. This migration may be slowed due to the viscosity of the air, and air escaping at the periphery may be replaced by new air introduced at the inlets 222 at a rate fast enough to prevent contact between the air cushion block 220 and the workpiece 102. Although described herein as air, it will be readily understood by those skilled in the art that any pressurized gas or fluid may be substituted for compressed air, and the scope of the present invention is intended to extend to the use of any such alternative fluids. Furthermore, although the present invention is described herein as comprising discrete passages 224 and outlet orifices 226, it will be understood by those skilled in the art that a porous media may be substituted for the discrete passageways and discrete outlet orifices. Accordingly, such substitutions are intended to fall within the scope of the present invention. For example, the outlet orifices 226 may comprise exposed surface pores of a porous material. The passages 224 may comprise internal pores of a porous material.

The air between the air cushion block 220 and the workpiece 102 may serve to provide a uniform pressure and maintain intimate contact between the workpiece 102 and the workpiece 106 when the fusing area is heated, and may also prevent internal deconsolidation of the workpieces 102, 106. The air flowing between the air cushion block 220 and the workpiece 102 may also serve to simultaneously cool the workpiece 102 as pressure is applied. Cooling of the surface of workpiece 102 is important because workpiece 102 may heat more rapidly than workpiece 106 when exposed to a magnetic field emanating from induction coil 214, due to the closer proximity of workpiece 102 to induction coil 214. The gap between the air cushion block 220 and the workpiece 102 may be relatively small, which may advantageously maintain the air in direct contact with the workpiece 102 as it migrates to the periphery of the air cushion block 220, preventing the formation of a boundary layer on the workpiece 102, and thereby enhancing heat transfer from the workpiece 102 into the air layer between the air cushion block 220 and the workpiece 102. Specifically, the gap between the air cushion block 220 and the workpiece 102 may be less than 3 mm, less than 2 mm, less than 1 mm, or less than 0.5 mm.

Importantly, the air flowing between the air cushion block 220 and the workpiece 102 may be disposed between the induction coil 214 and workpiece 102, thus enabling cooling at the same location of the workpiece 102 that is simultaneously heated by the induction coil 214. This arrangement is particularly advantageous when thermoplastic welding is performed with no susceptor layer at the weld interface, as in such case effective cooling of the surface of the workpiece 102 is critical. Susceptorless induction heating of a workpiece 102 tends to result in heating and softening of the workpiece 102 through its full thickness, not only at the weld interface. Therefore, a workpiece 102 heated by susceptorless induction heating may lack rigidity in the vicinity of heat application, and the workpiece 102 may thus be incapable of carrying clamping force from a remote location to the location of heat application. Accordingly, it may be essential to apply pressure directly at the location to which heat is applied and at the time that heat is applied. The configuration of the present invention addresses this need while also enabling the induction coil 214 to be positioned in close proximity to the workpiece 102, minimizing the magnetic field strength required to heat the workpieces 102, 106.

The air flowing between the air cushion block 220 and the workpiece 102 may also cool the surface of the air cushion block 220, which might otherwise accumulate heat from the workpiece 102 via radiation. This active cooling effect may advantageously allow the air cushion block 220 to be made of a material such as plastic or silicone rubber that is not capable of operating at the working temperature of the workpiece 102.

Consolidation pressure may only be required in melted or softened areas of the workpiece 102. Therefore, the area of the workpiece 102 over which the pressurized air of the present invention acts may be largely limited to that area of the workpiece 102 that is melted or softened by the induction coil 214. Applying pressure to a larger area outside the melted or softened area may generate an unnecessarily large force that must be reacted through the manipulator 202, and may reduce the amount of pressure that can be generated in the critical melted or softened area. In contrast to a conventional “air caster,” wherein the aim is to apply a force (e.g., to lift an object), and wherein the force generated can be increased by increasing the area over which the available air pressure acts, it is the aim of the present invention to apply a sufficient pressure to a softened or molten area of the workpiece 102 to maintain consolidation without regard to the total force produced. Thus, while it is typical in the case of an “air caster” to maximize the area to which pressure is applied while keeping the pressure itself low, such a configuration would not provide adequate consolidation pressure to a molten or softened area of a thermoplastic composite workpiece 102. In the case of the present invention, wherein the area acted upon may be confined to a molten or softened area of the workpiece 102, the pressure of the pressurized air between the air cushion block 220 and the workpiece 102 may be significantly higher. Specifically, the pressure of the pressurized air between the air cushion block 220 and the workpiece 102 may be at least 2 bar, at least 3 bar, at least 5 bar, at least 7 bar, at least 9 bar, or at least 11 bar.

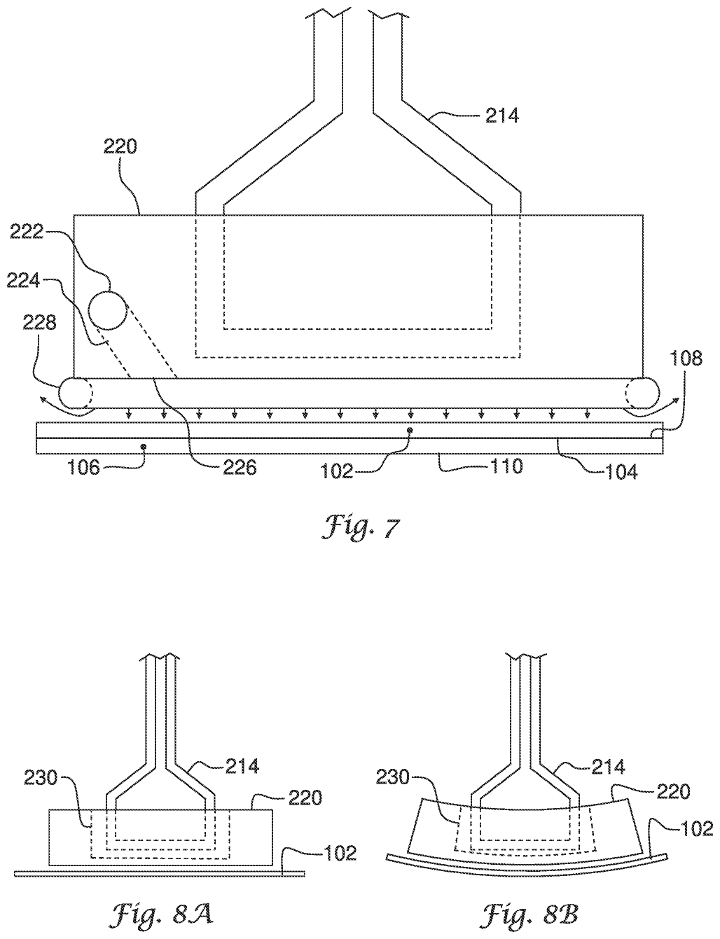

Referring now to FIG. 7, the air cushion block 220 may comprise a peripheral skirt 228 which may limit the rate at which pressurized air contained in the gap between the air cushion block 220 and the workpiece 102 may escape around the periphery of the air cushion block 220 in a manner analogous to the skirt of a hovercraft. The peripheral skirt 228 may be used in conjunction with a single passage 224 and outlet orifice 226 as depicted in FIG. 6, or may be used in conjunction with a plurality of passages 224 and outlet orifices 226. The peripheral skirt 228 may be made of a pliable material and may have a suitable cross section (e.g., a hollow tubular cross section) such that it may conform to local features or variations in contour of the workpiece 102.

Referring now to FIGS. 8A and 8B, in some embodiments, the air cushion block 220 may itself be flexible to allow the air cushion block 220 to adopt a contour generally corresponding to the local contour of the workpiece 102, while maintaining the air between the air cushion block 220 and the workpiece 102 as a thin film or layer of relatively uniform thickness. As discussed above, maintaining the pressurized air of the present invention as a thin film may advantageously promote uniform pressure and enhance heat transfer, and a flexible air cushion block 220 may enable these advantages to be achieved in circumstances in which the contour of the workpiece 102 is not uniform. FIG. 8A depicts an air cushion block 220 in a flat condition and FIG. 8B depicts the same air cushion block 220 in a curved or conformed condition.

It should be noted that some features of the air cushion block 220 are omitted from the depictions in FIGS. 8A and 8B for clarity. The air cushion block of FIGS. 8A and 8B includes a slot 230 for receiving a portion of the induction coil 214, which has clearance sufficient to allow the induction coil 214 to maintain its original shape despite a change in shape of the air cushion block 220. However, in some embodiments, the induction coil 214 may be molded into the air cushion block 220, or otherwise mechanically attached to the air cushion block 220. In such embodiments, portions of the induction coil 214 may be configured to flex along with the air cushion block 220, which may advantageously maintain portions of the induction coil 214 at a relatively constant distance from a surface of the workpiece 102, thereby heating the workpiece 102 more uniformly. An example of an embodiment of the present invention in which portions of the induction coil 214 are configured to flex along with the air cushion block 220 is illustrated in FIG. 11, which is described in more detail below.

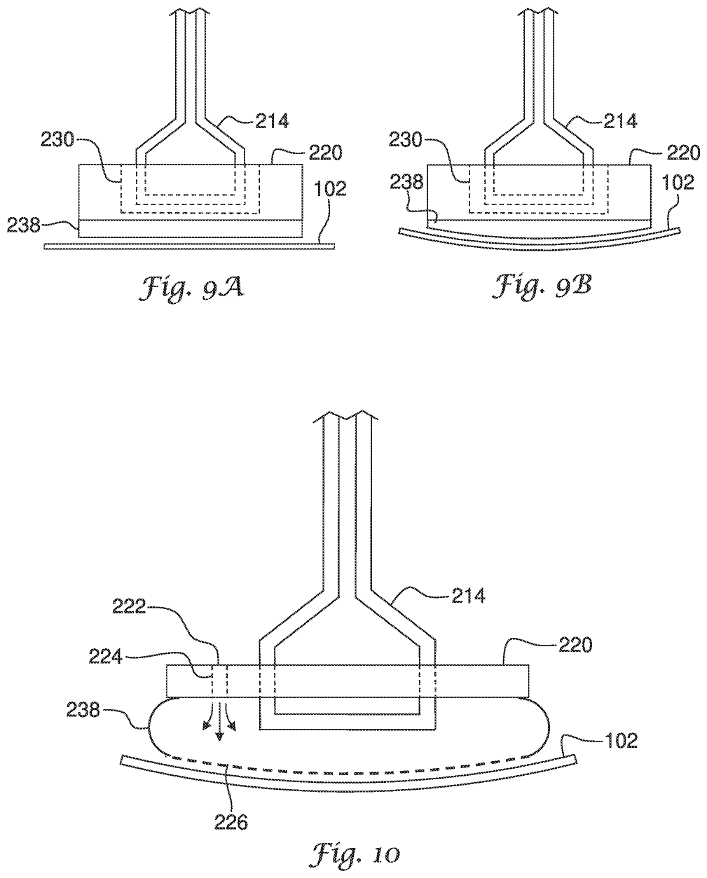

Referring now to FIGS. 9A and 9B, in some embodiments, the main body of the air cushion block 220 may be rigid, but a conformable portion 238 of the air cushion block 220 may conform to a surface of the workpiece 102. The conformable portion 238 may contain the outlet orifices 226 and at least a portion of the passages 224. The conformable portion 238 may be made of an elastomeric material such as silicone rubber or a porous material.

Referring now to FIG. 10, in some embodiments the conformable portion 238 of the air cushion block may comprise a perforated or porous flexible diaphragm. The diaphragm may be urged toward and conformed to the workpiece 102 by pressurized air introduced via the inlet 222. Some of the pressurized air may pass through the diaphragm and emerge from the outlet orifices 226, thereby forming a thin layer of air between the diaphragm and the workpiece 102 and causing the diaphragm to float slightly above and offset from the surface of the workpiece 102.

Referring now to FIG. 11, in some embodiments, the air cushion block may be segmented into multiple pieces 220a, 220b, 220c, 220d, each of which may receive compressed air from at least one separate secondary air line 218. Each segment 220a, 220b, 220c, 220d, may be independently urged toward the near workpiece 102 by at least one actuator 236 such as an air cylinder. Portions of the induction coil 214 may pass through apertures in the air cushion block segments 220a, 220b, 220c, 220d. Portions of the induction coil 214 may bend or flex as the air cushion block segments move independently and by different amounts as required for the air cushion block segments to adopt a contour, in the aggregate, corresponding generally to the contour of the near workpiece 102. The induction coil 214 may contribute to maintaining the air cushion block segments in approximate relative alignment with one another, in particular when the air cushion block segments are not engaged with the near workpiece 102. The air cushion block segments 220a, 220b, 220c, 220d may each contain internal passages 224 directing air from secondary air lines 218 to outlet orifices (not visible in FIG. 10), which internal passages may be formed in the segments via a 3D printing process.

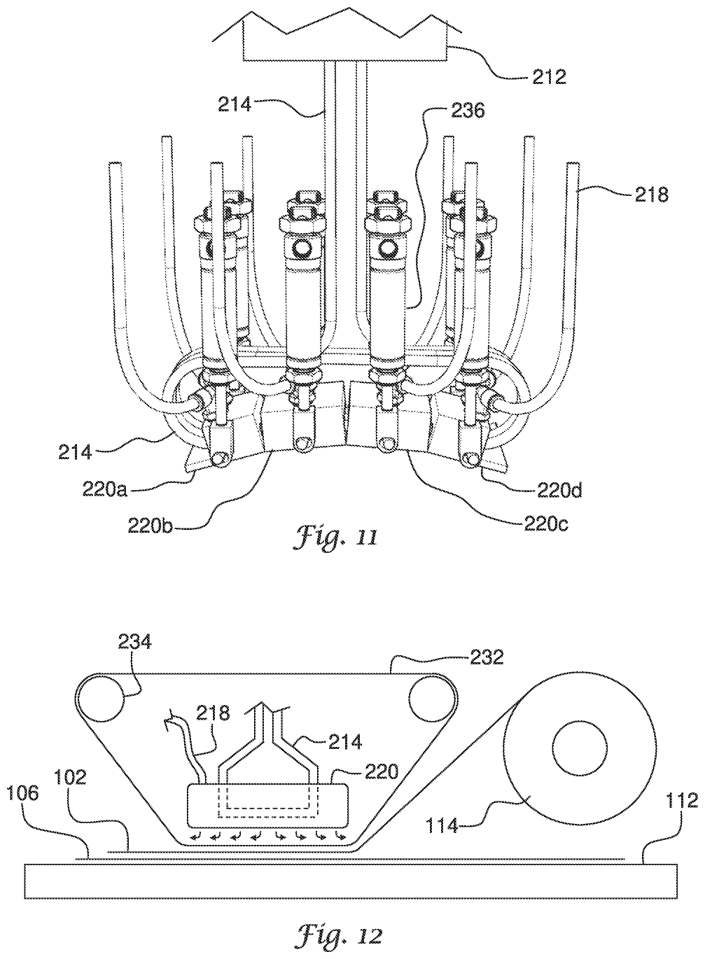

Although the present invention is described herein primarily in the context of thermoplastic “welding,” which is usually thought of as the joining of two pre-consolidated laminates, those skilled in the art will recognize that the present invention is also applicable to lamination, i.e., the process of fusing a single new ply of thermoplastic composite material to a previously deposited ply of thermoplastic composite material. Referring to FIG. 12, a system is disclosed by which a laminate may be constructed of two plies: a near ply constituting the near workpiece 102, and a far ply constituting the far workpiece 106. The near workpiece 102 (i.e., the newly deposited ply or near ply) may be dispensed from a roll 114 just prior to fusing to the far workpiece 106 (i.e., the previously deposited ply or far ply). The system of this embodiment may optionally further comprise a belt 232 which may recirculate around rollers 234, wherein the belt 232 may be interposed between the air cushion block 220 and the near workpiece 102. The use of an air cushion block 220 in place of the conventional compaction roller of a tape laying or automated fabric placement machine may enable a more uniform consolidation pressure to be applied over a greater area at once, facilitating a higher process speed.

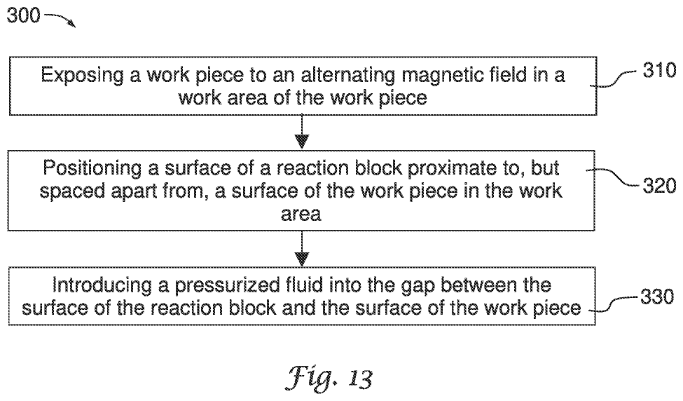

At least a portion of the steps of a method 300 for manufacturing a thermoplastic composite component using the system 100 and the apparatus 200 in accordance with various embodiments of the present invention are listed in FIG. 13. The steps may be performed in the order as shown in FIG. 13, or they may be performed in a different order. Further, some steps may be performed concurrently as opposed to sequentially. In addition, some steps may be omitted. Still further, embodiments of the present invention may be performed using systems other than system 100 and/or apparatuses other than apparatus 200 without departing from the scope of the technology described herein.

The method 300 may comprise a step of exposing a workpiece to an alternating magnetic field in a work area of the workpiece as depicted in flow chart block 310.

The method 300 may comprise a step of positioning a surface of a reaction block 220 proximate to, but spaced apart from, a surface of the workpiece 102 in the work area as depicted in flow chart block 320. The work area of the workpiece 102 described in flow chart blocks 310 and 320 may be a first work area of a plurality of work areas of the workpiece 102.

The method 300 may comprise a step of introducing a pressurized fluid into the gap between the surface of the reaction block 220 and the surface of the workpiece 102 as depicted in flow chart block 330. The step depicted in flow chart block 330 may be performed in parallel with the step depicted in flow chart block 310. Thus, pressure may be applied to a location of the workpiece 102 at the same time heat is applied to such location.

The method 300 may comprise a step of moving the reaction block over the surface of the workpiece to a second work area.

The method 300 may comprise a step of exposing the workpiece to an alternating magnetic field at the second work area.

The method 300 may comprise a step of maintaining pressurized fluid in the gap between the surface of the reaction block 220 and the surface of the workpiece 102 as the reaction block 220 is moved from the first work area of the workpiece 102 to the second work area of the workpiece 102, and as the second work area of the workpiece 102 is exposed to an alternating magnetic field.

Although the invention has been described with reference to the preferred embodiments illustrated in the attached drawing figures, it is noted that equivalents may be employed and substitutions made herein without departing from the scope of the invention as recited in the claims.

1. An apparatus for fusing a far surface of a near thermoplastic work piece to a near surface of a far thermoplastic work piece, the apparatus comprising:
an induction coil configured to heat a fusing area of the near thermoplastic work piece and the far thermoplastic work piece; and
an air cushion block configured to emit compressed air into a space between the induction coil and a near surface of the near thermoplastic work piece in the fusing area, urging the near thermoplastic work piece toward the far thermoplastic workpiece.

2. The apparatus of claim 1, wherein the compressed air is emitted from the air cushion block through a plurality of outlet orifices distributed over a surface of the air cushion block facing a near surface of the near work piece.

3. The apparatus of claim 1, wherein the air cushion block further comprises a peripheral skirt.

4. The apparatus of claim 2, wherein the plurality of outlet orifices comprise discrete orifices in fluid communication with at least one compressed air inlet via discrete passages.

5. The apparatus of claim 2, wherein the plurality of outlet orifices comprise exposed pores of a porous material, and wherein the exposed pores of the porous material are in fluid communication with at least one compressed air inlet via internal pores of the porous material.

6. The apparatus of claim 2, wherein the air cushion block is configured to conform to a shape generally corresponding to a shape of the near thermoplastic work piece.

7. The apparatus of claim 6, wherein a portion of the induction coil is positioned within a slot of the air cushion block, wherein the slot has sufficient clearance with respect to the induction coil to allow the air cushion block to conform to a shape generally corresponding to a shape of the near thermoplastic work piece without changing the shape of the induction coil.

8. The apparatus of claim 6, wherein the induction coil is mechanically coupled to the air cushion block, and wherein a portion of the induction coil is configured to conform to a shape generally corresponding to a shape of the near thermoplastic work piece along with the air cushion block.

9. The apparatus of claim 8, wherein the air cushion block comprises a plurality of segments, each configured to move independently of other segments, and wherein by moving independently, the segments together adopt an overall shape generally corresponding to a shape of the near thermoplastic work piece.

10. A system for fusing a thermoplastic composite material, the system comprising:
an induction fusing apparatus comprising an induction coil;
a pressurized fluid disposed between the induction coil of the induction fusing apparatus and the thermoplastic composite material;
a tool configured to react force applied by the pressurized fluid to the thermoplastic composite material; and
a manipulator configured to move the induction fusing apparatus along a surface of the thermoplastic composite material.

11. The system of claim 10, wherein the pressurized fluid is emitted by the induction fusing apparatus.

12. The system of claim 11, wherein the pressurized fluid comprises compressed air.

13.-17. (canceled)

18. A method for applying heat and pressure to a work piece, the method comprising:
exposing the work piece to an alternating magnetic field at a first work area;
positioning a surface of a reaction block proximate to, but spaced apart from, a surface of the work piece at the first work area; and
introducing a pressurized fluid into the gap between the surface of the reaction block and the surface of the work piece as the first work area is exposed to the alternating magnetic field.

19. The method of claim 18, further comprising moving the reaction block over the surface of the work piece to a second work area.

20. The method of claim 18, wherein the gap between the surface of the reaction block and the surface of the work piece is less than 1 mm.

21. The method of claim 20, further comprising exposing the work piece to an alternating magnetic field at the second work area.

22. The method of claim 21, wherein pressurized fluid is maintained in the gap between the surface of the reaction block and the surface of the work piece as the reaction block is moved from the first work area to the second work area and as the second work area is exposed to an alternating magnetic field.

23. The method of claim 18, wherein the reaction block comprises an induction coil, and wherein the alternating magnetic field to which the work piece is exposed emanates from the induction coil.
